(19) United States
(12) Patent Application Publication
(10) Pub. No.: US 2026/0073732 A1
(43) Pub. Date: Mar. 12, 2026

(54) SYSTEM AND METHOD FOR REAL-TIME DETECTION OF DEEPFAKES

(71) Applicant: Ensign Infosecurity Pte. Ltd., Singapore (SG)

(72) Inventors: Joon Sern Lee, Singapore (SG); Divakar Sivashankar, Singapore (SG); Ting Yew Koh, Singapore (SG); Karthik Ravikanti, Singapore (SG); Aratrika Pal, Singapore (SG)

(21) Appl. No.: 19/181,997

(22) Filed: Apr. 17, 2025

(30) Foreign Application Priority Data
Sep. 9, 2024 (SG) 10202402792Y
Feb. 10, 2025 (SG) 10202500371Q

(51) Int. Cl. G06V 40/40; G06V 10/42; G06V 10/82

(52) U.S. Cl. CPC G06V 40/40; G06V 10/421; G06V 10/82

(57) ABSTRACT

This document describes a system and method for detecting deepfakes in real-time. In particular, the described system and method is configured to detect, in real-time, if a captured image and/or audio segment comprises a deepfake

### CROSS REFERENCE TO RELATED APPLICATION

This application claims the benefit of priority to Singapore patent application no. 10202402792Y which was filed on 9 Sep. 2024 and Singapore application no. 10202500371Q filed on 10 Feb. 2025, the contents of which are hereby incorporated by reference in its entirety for all purposes.

### TECHNICAL FIELD

This application relates to a system and method for detecting deepfakes in real-time. In particular, the system and method is configured to detect, in real-time, if a captured image and/or audio segment comprises a deepfake.

### BACKGROUND

Deepfakes are increasingly exploited by attackers to carry out highly realistic and sophisticated attacks against individuals and organizations for both monetary and non-monetary purposes, such as information theft and reputational damage. As a result, those skilled in the art have proposed various solutions to tackle this deepfake problem. Among the solutions proposed by those skilled in the art include methods that involve the analysis of heart rates based on uploaded videos to detect deepfakes, utilizing platforms like DeepWare for deepfake analysis via manual or programmatic video uploads, and employing technologies for parallel file scanning and real-time endpoint analysis to identify manipulated content.

Most of the solutions proposed by those skilled in the art rely on web-based platforms or Application Programming Interfaces (APIs) where users are required to upload videos or audio files for analysis. While such approaches may be effective for detecting deepfakes, this deployment mode limits their use to forensic investigations, as it requires a significant number of extra steps to be carried out by users of such solutions. For example, video call participants would need to record their screens, upload the recorded files to a platform, and wait for these files to be analyzed before the user may continue on with their call. Consequently, these solutions are better suited for post-incident investigations by digital forensic experts rather than real-time detection.

In another solution proposed by those skilled in the art, the proposed solution analyzes on screen faces in real-time during video calls but this solution lacks functionality for detecting deep-fake voices. In yet another solution, a browser plugin for real-time audio analysis was proposed, however, this solution was limited to the analysis of audio streams that were only provided within the browser. This proposed solution excluded audio from applications outside the browser, rendering the solution ineffective for video call platforms that operate as standalone applications.

Another limitation of these solutions is that they are usually implemented as standalone tools, or “point solutions,” and as such are not able to be integrated into broader security processes. This lack of integration reduces their utility in comprehensive security frameworks, leaving a gap in real-time, multi-modal deep-fake detection systems capable of protecting individuals and organizations seamlessly during live interactions. Hence, despite the efforts of those skilled in the art, it's still a challenge to address the detection of deepfakes in real-time at a user's endpoint, i.e., laptops, desktops, etc.

### SUMMARY

In one aspect of the present disclosure, a computing module for real-time detection of deepfakes is disclosed where the module comprises a processing unit, and a non-transitory media readable by the processing unit. The media stores instructions that when executed by the processing unit causes the processing unit to acquire an image and extract at least one facial image from the image (if a face exists), apply a trained deepfake visual detection model to the at least one extracted facial image, the deepfake visual detection model performing a binary classification of the at least one facial image to determine if the at least one facial image comprises manipulations, and a per-pixel classification of the at least one facial image to generate a mask indicating regions of potential manipulation. The processing unit then proceeds to determine if the acquired image comprises a deepfake image based on the binary and the per-pixel classifications of the at least one facial image. In a further embodiment of this aspect, the processing unit then proceeds to acquire an audio segment and pre-process the audio segment, reconstruct original audio characteristics of the pre-processed audio segment using a trained audio inverter model, apply a trained deepfake audio detection model to the reconstructed original audio characteristics, the deepfake audio detection model performing classification of the reconstructed original audio characteristics and determine if the acquired audio segment comprises a deepfake audio based on the classification of the reconstructed original audio characteristics

In a further embodiment of this aspect, the reconstructing of the original audio characteristics comprises instructions for directing the processing unit to cause the trained audio inverter model to reverse transformations introduced by the operating system sound mixer to reconstruct the original audio characteristics approximating an original audio signal of the acquired audio segment.

In a further embodiment of this aspect, the audio inverter model comprises a bi-directional long short-term memory neural network or a convolutional neural network that was trained based on a dataset of audio-transformations representative of distortions introduced by the operating system sound mixer.

In a further embodiment of this aspect, the deepfake visual detection model comprises a MobileNet image segmentation model configured to segment a received extracted facial image and generate a manipulation mask (which provides the per-pixel classification as to whether each pixel of the face is manipulated by deepfake algorithms or not), a concatenation module configured to concatenate the manipulation mask with the received extracted facial image to produce a multi-channel output, a first convolutional neural network configured to apply same convolution to the multi-channel output to extract spatial features and to preserve input height and width dimensions, a second convolutional neural network configured to apply valid convolution to the processed output of the first convolutional neural network to reduce spatial dimensions and increase feature depth of the processed output, a first flattening layer configured to flatten processed output of the second convolutional neural network into a one-dimensional feature vector, and a first multi-layer perceptron neural network configured to process the feature vector to generate the binary classification to determine whether the at least one facial image is a deepfake face or not.

In a further embodiment of this aspect, the deepfake audio detection model comprises a third convolutional neural network configured to apply same convolution to a frequency spectrum derived from received audio characteristics to extract spatial features and to preserve input height and width dimensions, a fourth convolutional neural network configured to apply valid convolution to the processed output of the third convolutional neural network to reduce spatial dimensions and increase feature depth of the processed output, a second flattening layer configured to flatten processed output of the fourth convolutional neural network into a one-dimensional feature vector, and a second multi-layer perceptron neural network configured to process the feature vector to generate the classification as to whether the reconstructed original audio has deepfake characteristics or not.

In another aspect of the present disclosure, a method for real-time detection of deepfakes using a computing module is disclosed. The disclosed method comprising the steps of acquiring an image and extracting at least one facial image from the image (if available), applying a trained deepfake visual detection model to the at least one extracted facial image, the visual detection model performing a binary classification of the at least one facial image to determine if the at least one facial image comprises manipulations and a per-pixel classification of the at least one facial image to generate a mask indicating regions of potential manipulation. The method then proceeds to determine if the acquired image comprises a deepfake image based on the binary and the per-pixel classifications of the at least one facial image. The method then further acquires an audio segment and pre-process the audio segment, reconstructs original audio characteristics of the pre-processed audio segment using a trained audio inverter model, applies a trained deepfake audio detection model to the reconstructed original audio characteristics, the audio detection model performing classification of the reconstructed original audio characteristics and determines if the acquired audio segment comprises a deepfake audio based on the classification of the reconstructed original audio characteristics.

### BRIEF DESCRIPTION OF THE DRAWINGS

Various embodiments of the present disclosure are described below with reference to the following drawings:

FIG. 1 illustrates a block diagram representative of a system for detecting deepfakes in real-time based on captured audio-visual data in accordance with embodiments of the present disclosure;

FIG. 2 illustrates a block diagram representative of a processing system for performing embodiments of the present disclosure;

FIG. 3 illustrates a block diagram representative of a system for training a deepfake visual detection model in accordance with embodiments of the present disclosure;

FIG. 4 illustrates a block diagram representative of modules contained within a deepfake visual detection model in accordance with embodiments of the present disclosure;

FIG. 5 illustrates a block diagram representative of modules contained within a deepfake audio detection model in accordance with embodiments of the present disclosure;

FIG. 6 illustrates audio spectrograms before and after these audio clips have been transformed by an operating system's audio mixer;

FIG. 7 illustrates audio spectrograms before and after audio clips transformed by an operating system's audio mixer have been reconstructed by an audio inverter model in accordance with embodiments of the present disclosure; and

FIG. 8 illustrates a flowchart showing a process for detecting deepfakes in real-time in accordance with embodiments of the disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

As used herein, the terms “first,” “second,” and the like in the description, in the claims, and in the figures are used for distinguishing between similar objects and not necessarily for describing a particular sequential or chronological order.

As used herein, the term “same convolution” and the like in the description refers to a convolutional operation in which padding is applied to the input data to ensure that the spatial dimensions (height and width) of the output feature map are the same as those of the input. In embodiments of the disclosure, this may be achieved by adding an appropriate amount of padding around the edges of the input so that the kernel can fully traverse the input without reducing its size. Convolutional neural networks usually adopt same convolution to preserve spatial resolutions, enabling the network to maintain alignment between input and output dimensions across layers. Such an approach is useful in image segmentation tasks that require pixel-level predictions.

As used herein, the term “valid convolution” and the like in the description refers to a convolutional operation in which no padding is applied to the input data. This means that the convolution kernel is only applied to regions where the kernel fully overlaps with the input. As a result, the spatial dimensions (height and width) of the output feature map are smaller than those of the input, depending on the size of the kernel. Valid convolution is often used in convolutional neural networks to progressively reduce the spatial dimensions of the input, enabling the network to focus on key features while decreasing computational complexity. Such an approach is particularly useful in hierarchical feature extraction tasks, where deeper layers capture more abstract representations of the input data.

As used herein, the term “deepfake” and the like in the description in relation to audio and visual data refers to synthetic or manipulated media generated using artificial intelligence techniques where these manipulated media are often designed to imitate real individuals'voices or appearances. Deepfake audio usually involves fake speech which has been created to mimic a person's voice while deepfake visuals usually involves the manipulation of visual content to replace or modify faces and/or expressions in a way that appears authentic.

Further, one skilled in the art will recognize that certain functional units in this description have been labelled as modules, sub-modules or sets of processing elements throughout the specification. The person skilled in the art will also recognize that a module, a sub-module or a set of processing elements may be implemented as circuits, logic chips or any sort of discrete component. Still further, one skilled in the art will also recognize that a module, a sub-module or a set of processing elements may be implemented in software which may then be executed by a variety of processor architectures. In embodiments of the disclosure, a module, a sub-module or a set of processing elements may also comprise computer instructions, computations or executable code that may instruct a computer processor to carry out a sequence of events based on instructions received. The choice of the implementation of the modules, the sub-modules or the sets of processing elements is left as a design choice for a person skilled in the art and does not limit the scope of the claimed subject matter in any way.

In embodiments of the disclosure, a computing module configured for real-time detection of deepfakes may be designed to run on endpoints such as laptops, desktops, and other similar devices. When the computing module is in use, the computing module may be configured to scan connected screens for visual deepfakes and may be configured to analyze the system-level audio output to identify potential deepfake audio content being played to a user of the endpoint.

Upon detection of an audio and/or visual deepfakes, the computing module then proceeds to upload relevant artifacts, such as fake faces or audio snippets identified by the computing module, to a database. Further, the computing module may also generate detection logs containing details such as the computer name, username, timestamp, detection confidence, and any other relevant details, which are then uploaded to the same database or a security information and event management system. These logs enable security analysts to correlate the deepfake alerts with other security events, such as phishing or insider threats, and take preventive or mitigative actions to minimize the impact of the attack.

FIG. 1 illustrates computing module 100 for real-time detection of deepfakes based on audio visual data in accordance with embodiments of the present disclosure whereby computing module 100 is designed to run on endpoints. Computing module 100 comprises audio-visual module 102 that is configured to operate across both audio and visual modalities at the endpoint. Audio-visual module 102 scans all screens connected to the endpoint to identify and capture visual and audio content, regardless of the application in use. This application-agnostic approach of audio-visual module 102 ensures that computing module 100 may work seamlessly across various video conferencing platforms such as, but are not limited to, Teams, Zoom, Chrome, or Media Player, as long as the content is displayed on the screen or played through the speakers at the endpoint.

Computing module 100 comprises two primary processing pipelines, a first pipeline for processing captured visual data and a second pipeline for processing captured audio data. The outcomes generated by both audio-visual pipelines are ultimately combined and processed at alert notification module 118. The first pipeline in computing module 100 comprises extraction module 104 for isolating relevant visual data, deepfake visual detection module 106, comprising a deepfake visual detection module, for detecting manipulated visual content, a visual decision module 108 for making classification decisions based on the processed visual data. The second pipeline comprises preprocessing module 110 for preparing audio data, audio inverter module 112 for reversing audio distortions made by the operating system, deepfake audio detection module 114 for detecting manipulated audio content, and audio decision module 116 for determining whether the audio data contains deepfake characteristics.

In embodiments of the disclosure, extraction module 104 is configured to acquire visual data from audio-visual module 102, where the visual data may comprise, but is not limited to, video files in the MP4, AVI, MKV or etc. formats and/or static images in the JPG, PNG, BMP or etc. formats and/or screen video captures of screens connected to the user's device. Extraction module 104 then processes the video stream by capturing still images (i.e., frames) of the video files, either for a limited or continuous period to generate a plurality of static images. These static images which are obtained from the video files or directly from audio-visual module 102 are then preprocessed by extraction module 104 to detect and extract at least one facial image from each of these images (if present). In embodiments of the disclosure, each of the faces that have been detected and extracted may be resized as required, e.g., resized to 512×512 pixels, before each of the resized facial images are analyzed by deepfake visual detection module 106.

Deepfake visual detection module 106 then utilizes a trained deepfake visual detection model to analyze each of the extracted resized faces, also referred to as facial images, to determine (1) the probability that the analyzed facial image is a fake and (2) the probability that each pixel has been manipulated by deepfake algorithms for each pixel of the face. The trained deepfake visual detection model achieves this by performing a binary classification of the at least one facial image to determine if the at least one facial image comprises manipulations, and a per-pixel binary classification of the at least one facial image to generate a mask indicating regions of potential manipulation. Visual decision module 108 then utilizes these results from deepfake visual detection module 106 to determine if a static image comprises a deepfake face within the image.

In embodiments of the disclosure, alert notification module 118 may evaluate the results produced by visual decision module 108 to determine whether more screenshots with fake facial images were detected than those without within a predetermined time period, i.e., within the last 10 seconds. If this threshold is exceeded, alert notification module 118 will then raise an alert to notify users or relevant systems of potential deepfake activity to ensure that an immediate response may be taken to address the detected deepfake images.

In embodiments of the disclosure, audio-visual module 102 may be configured to continuously pull an audio stream from an endpoint's operating system's sound mixer and to store it in a bounded buffer. Preprocessing module 110 may then be configured to extract an oldest predetermined time-window of the stored audio stream, e.g., a 15-second window of audio, from the buffer of audio-visual module 102 to obtain an audio segment. Preprocessing module 110 may then preprocess the audio segment by resampling and/or converting the audio segment into another format, e.g., 16 kHz, float32 audio data.

Audio inverter module 112 then utilizes a trained audio inverter model to reconstruct original audio characteristics of the pre-processed audio segment. This process reconstructs the audio segment by reversing transformations introduced by the operating system's sound mixer to obtain a best estimate of the original audio stream's characteristics, prior to distortions introduced by the operating system's sound mixer. The reconstructed audio is then analyzed by deepfake audio detection module 114 which utilizes a trained deepfake audio detection model to classify whether the reconstructed original audio characteristics contains deepfake audio characteristics. The outcome from deepfake audio detection module 114 is then utilized by audio decision module 116 to determine if the acquired audio segment comprises a deepfake audio segment. In embodiments of the disclosure, alert notification module 118 may evaluate the results produced by audio decision module 116 to determine whether more audio is classified as fake than real within a predetermined time period, i.e., within the last 10 seconds. If this threshold is exceeded, alert notification module 118 will then raise an alert to notify users or relevant systems of potential deepfake activity to ensure that an immediate response may be taken to address the detected deepfake audio segments.

In embodiments of the disclosure, alert notification module 118 may be configured to generate notifications within a predetermined time period, e.g., every 10 seconds, if potential deepfakes (visual or audio) are detected within that time period, e.g., within the past 10 seconds. In addition to the generation of these notifications, alert notification module 118 may be configured to process the detected audio and/or visual data into logs, before this data is uploaded into a database along with the corresponding data, such as the detected fake facial images and fake audio segments identified by the model. These alerts and corresponding data can be integrated into a security information and event management system to enable security analysts in security operations centers to perform downstream investigations, correlate events, and implement remediation measures.

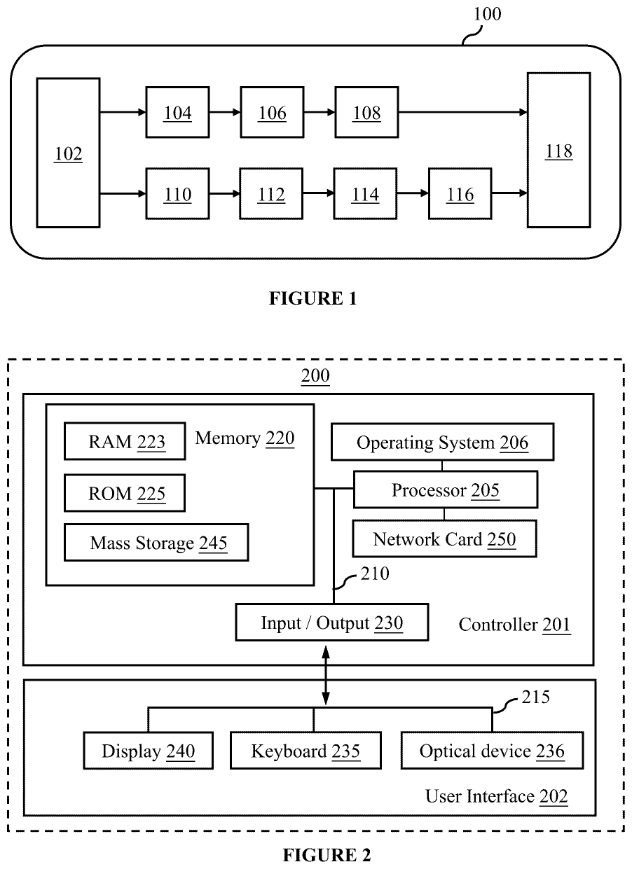

In accordance with embodiments of the present disclosure, a block diagram representative of components of processing system 200 that may be provided within computing module 100 and the various modules contained therein to carry out the digital signal processing functions or computations in accordance with embodiments of the disclosure, or any other modules or sub-modules of the system is illustrated in FIG. 2. One skilled in the art will recognize that the exact configuration of each processing system provided within these modules or sub-modules may be different and the exact configuration of processing system 200 may vary and the arrangement illustrated in FIG. 2 is provided by way of example only.

In embodiments of the disclosure, processing system 200 may comprise controller 201 and user interface 202. User interface 202 is arranged to enable manual interactions between a user and the computing module as required and for this purpose includes the input/output components required for the user to enter instructions to provide updates to each of these modules. A person skilled in the art will recognize that components of user interface 202 may vary from embodiment to embodiment but will typically include one or more of display 240, keyboard 235 and optical device 236.

Controller 201 is in data communication with user interface 202 via bus 215 and includes memory 220, processing unit, processing element or processor 205 mounted on a circuit board that processes instructions and data for performing the method of this embodiment, an operating system 206, an input/output (I/O) interface 230 for communicating with user interface 202 and a communications interface, in this embodiment in the form of a network card 250. Network card 250 may, for example, be utilized to send data from these modules via a wired or wireless network to other processing devices or to receive data via the wired or wireless network. Wireless networks that may be utilized by network card 250 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 220 and operating system 206 are in data communication with processor 205 via bus 210. The memory components include both volatile and non-volatile memory and more than one of each type of memory, including Random Access Memory (RAM) 223, Read Only Memory (ROM) 225 and a mass storage device 245, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 220 may include a kernel and/or programming modules such as a software application that may be stored in either volatile or non-volatile memory.

Herein the term “processor” is used to refer generically to any device or component that can process such instructions and may include: a microprocessor, a processing unit, a plurality of processing elements, a microcontroller, a programmable logic device or any other type of computational device. That is, processor 205 may be provided by any suitable logic circuitry for receiving inputs, processing them in accordance with instructions stored in memory and generating outputs (for example to the memory components or on display 240). In this embodiment, processor 205 may be a single core or multi-core processor with memory addressable space. In one example, processor 205 may be multi-core, comprising—for example—an 8 core CPU. In another example, it could be a cluster of CPU cores operating in parallel to accelerate computations.

### Training the Deepfake Visual Detection Model

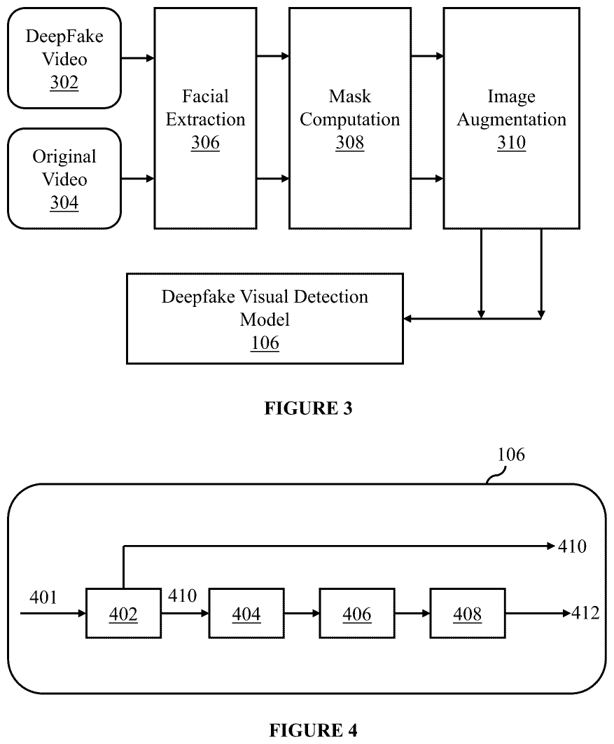

In embodiments of the disclosure, the training of the deepfake visual detection model (as provided within deepfake visual detection module 106) may be divided into two stages, the first stage comprising a data preprocessing stage and the second stage comprising a model training stage. A block diagram representative of the first and second stages for training the deepfake visual detection model in accordance with embodiments of the present disclosure is illustrated in FIG. 3. In embodiments of the disclosure, the first stage may be performed by modules 306, 308 and 310 while the second stage may be performed by deepfake visual detection module 106 based on the data generated in the first stage.

In embodiments of the disclosure, the training of the deepfake visual detection model is performed using various types of datasets including open-source and in-house datasets. Regardless of the type of dataset used, for every deepfake video 302 in the dataset, there would be corresponding original video 304. In embodiments of the disclosure, the dataset should comprise at least 500 GB of video training data, spanning multiple compression and codec types.

As shown in FIG. 3, each deepfake video 302 is paired with a corresponding original video 304 containing the same number of frames. For each video frame, facial extraction module 306 then proceeds to extract facial images from each frame of deepfake video 302 using facial detection algorithms, resulting in bounding boxes for each detected facial image in each frame of deepfake video 302. These bounding boxes are then applied to the corresponding frame in original video 304 to obtain the corresponding matching real facial images. The detailed workings of the facial detection algorithms are omitted for brevity as they are known to one skilled in the art.

Mask computation module 308 then computes image difference masks based on the facial image pairs (i.e., real and original facial images) extracted by facial extraction module 306. In particular, mask computation module 308 computes the difference between each deepfake facial image and its corresponding original facial image using binary thresholding and Otsu thresholding to produce a mask that highlights the manipulated pixels in the deepfake facial image. For the original facial images, mask computation module 308 generates zero-difference masks, which comprise matrices of zeros with dimensions identical to the original facial image and this indicates the absence of manipulation. Upon the completion of this process, mask computation module 308 outputs two pairs of data for each video frame: (1) a deepfake facial image paired with its corresponding difference mask and (2) an original facial image paired with a zero-difference mask.

Image augmentation module 310 then independently applies image augmentation techniques such as random changes to hue, saturation, and brightness to each facial image produced by mask computation module 308. The augmented facial images, along with their corresponding masks, are then used to train the deepfake visual detection model. In other words, the final preprocessed video data which comprises of pairs: (augmented deepfake facial image, difference mask) and (augmented original facial image, zero-difference mask) are used to train deepfake visual detection module 106. It should be noted that deepfake video 302 and original video 304 may be replaced with deepfake static images and original static images respectively in FIG. 3, and modules 306, 308 and 310 may be configured to process these static image pairs in the similar manner as described above.

A block diagram showing the training process of deepfake visual detection model is illustrated in FIG. 4. The primary goal of the model training is to develop an AI model capable of producing two outputs: (1) a binary classification indicating whether a facial image is real or fake and (2) a predicted mask that segments the image to identify the specific pixels manipulated by deepfake algorithms. These two outputs may then be used to enable both classification and localization of deepfake manipulations.

The process of training the deepfake visual detection model begins with preprocessed video data 401, which comprises of pairs of facial images and their corresponding masks, along with labels indicating whether the facial images are real or fake, being provided to MobileNet 402. The MobileNet architecture was selected in order to ensure that the model is efficient enough to run on endpoint devices while maintaining robust detection performance. The detailed workings of MobileNet are omitted for brevity as it is well known to one skilled in the art, especially in the field of image segmentation. MobileNet 402 is then configured to perform an image segmentation process to identify regions that have been manipulated in the facial images and generates predicted manipulation mask 410.

A concatenation module (not shown) then concatenates manipulation mask 410 with the augmented original facial image, which consists of three channels (red, green, and blue), to produce a multi-channel output, i.e., a four-channel output comprising red, green, blue, and the manipulation mask 410. This multi-channel output is then provided to a convolutional neural network (CNN) layer 404 which is configured to perform same convolution on the multi-channel output to extract spatial features and to preserve input dimension of the multi-channel output. CNN layer 406 then proceeds to apply valid convolution to the output of CNN layer 404 to reduce spatial dimensions and increase feature depth of the processed output from CNN layer 404. The output from CNN layer 406 is then flattened into a one-dimensional feature vector using a flattening layer (not shown). The feature vector is then utilized by multi-layered perceptron (MLP) 408 to perform the binary classification of the facial image, i.e., to determine if the facial image is original or fake.

In embodiments of the disclosure, deepfake visual detection module 106 may be trained using a combination of two loss functions. The first is a per-pixel binary classification loss, which compares the predicted manipulation mask generated by MobileNet to the ground-truth masks created during the data preprocessing stage, i.e., the first stage. The second is a binary classification loss that measures the difference between the predicted probability of a facial image being fake and the actual label provided during preprocessing. Advanced optimizers with periodic learning rates may be used to train the entire model end-to-end, ensuring convergence and optimal performance.

In other embodiments of the disclosure, the CNN layers 404 and 406 may be replaced with recurrent neural networks (e.g., gated recurrent units) or transformer based models without departing from this disclosure.

### Training the Deepfake Audio Detection Model

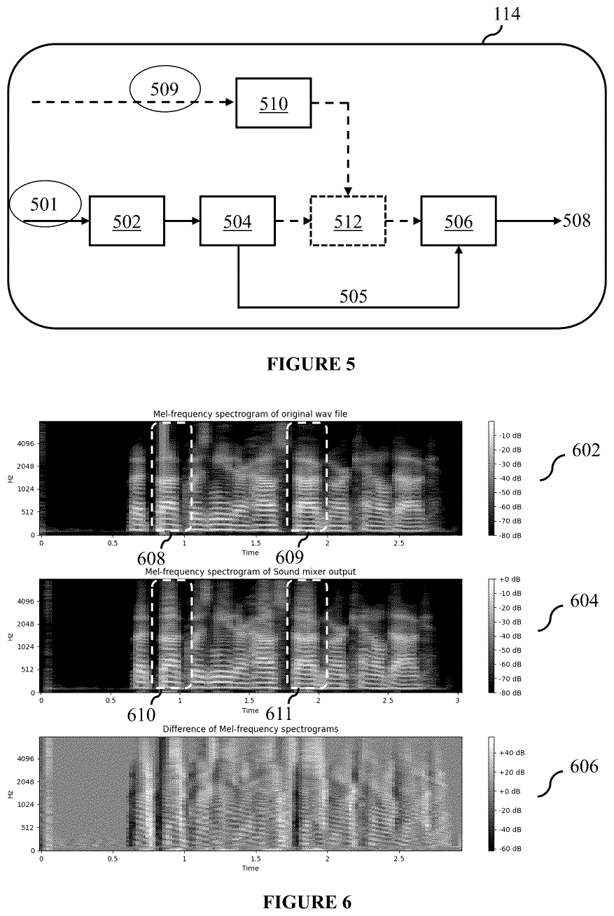

In embodiments of the disclosure, the training of deepfake audio detection model (as provided within deepfake visual module 114) may be divided into two stages, the first stage comprising a data preprocessing stage and the second stage comprising a model training stage. A block diagram representative of the training of the deepfake audio detection model in accordance with embodiments of the present disclosure is illustrated in FIG. 5.

The data preprocessing stage generates training audio samples by creating 15-second audio clips labeled as either real or fake. For real samples, up to 10 real audio clips are randomly sampled, and a 5-second segment is extracted from each. These segments are concatenated with a maximum overlap of 10% to simulate scenarios like multiple people speaking simultaneously during a video call. These concatenated audio clips are then labeled as real audio clips. For fake samples, 10 audio clips are sampled, with at least half of them being fake, and similar 5-second segments are extracted and concatenated to form a 15-second clip. This process is designed to mimic realistic multi-speaker audio scenarios while ensuring a balanced dataset of real and fake audio samples.

To enhance the robustness and generalizability of the audio dataset, various audio augmentation techniques may be applied to the audio clips. These include introducing random noise, modifying the amplitude, applying random frequency masking, and performing random time masking. Each augmented audio clip is paired with its corresponding label (real or fake), forming a training sample. By the end of this preprocessing stage, the dataset consists of diverse, augmented audio clips that effectively simulate real-world audio conditions, ensuring the model can generalize well to unseen data. One skilled in the art will recognize that any number of audio clips, e.g. more than 10 audio clips, or that the audio clips in the training samples may comprise of shorter or longer time periods without departing from this disclosure and that the time periods and numbers of audio clips provided above are meant to be non-limiting examples.

At the end of the audio data preprocessing stage, each training sample comprises an augmented audio clip and its corresponding label, i.e., real or fake. With reference to FIG. 5, the augmented audio is then transformed into both its time-domain representation 509, i.e., the raw signal and its frequency-domain representation 501, i.e., the frequency spectrogram. In embodiments of the disclosure, frequency-domain representation 501 is provided to CNN layer 502 which is configured to apply same convolution to frequency-domain representation 501 to extract spatial features from and to preserve input dimensions of frequency-domain representation 501. CNN layer 504 is then configured to apply valid convolution to the processed output from CNN layer 502, and this reduces the spatial dimensions and increases the feature depth of the processed output from CNN layer 502. In embodiments of the disclosure, the output from CNN layer 504 is then passed along path 505, directly to multi-layered perceptron 506 to generate the classification of the augmented audio clip, i.e., the probability the audio is fake or real.

In another embodiment of the disclosure, trained Wav2Vec module 510 may be provided to process time-domain representation 509 before the features extracted by Wave2Vec module 510 is concatenated with the output from CNN layer 504 using concatenation module 512. The concatenated outputs from module 512 may then be provided to multi-layered perceptron 506 to generate the classification of the augmented audio clip, i.e., the probability the audio is fake or real. The Wav2Vec model used by Wave2Vec module 510 may comprise a neural network architecture designed for self-supervised learning of speech representations directly from raw audio waveforms. The detailed training of the Wav2Vec model is omitted for brevity as it is well known to one skilled in the art.

In either embodiment, the entire neural network may be trained end-to-end using binary cross-entropy loss, which measures the difference between the predicted probability and the actual label. Additionally, advanced optimizers with varying or periodic learning rates may also be employed to ensure efficient training and convergence.

In other embodiments of the disclosure, the CNN layers 502 and 504 may be replaced with recurrent neural networks (e.g., gated recurrent units) or transformer based models without departing from this disclosure.

### Audio Inverter Model

Audio streamed through an operating system's audio mixer, e.g., a Windows system audio mixer, typically becomes distorted or transformed as the audio mixer changes the audio characteristics of different programs separately so that the audio presented to the user of the system blends seamlessly with other sounds or notifications produced by the operating system. This manipulation by the audio mixer results in noticeable differences between the original audio file and the audio output of the audio mixer, as can be seen from the exemplary spectrograms illustrated in FIG. 6. Spectrogram 602 illustrates the spectrogram of the original audio file, spectrogram 604 illustrates the spectrogram of the audio file after it has been modified by the OS audio mixer and spectrogram 606 illustrates the differences between spectrogram 602 and spectrogram 604. As can be seen in FIG. 6, there are huge differences between spectrogram 602 and 604 as highlighted by dashed circles 608, 609, 610 and 611. In fact, the frequency spectrogram 604 after processing by the OS audio mixer seems to be a “blurred” version of the original input spectrogram 604. This discrepancy presents a major issue for deepfake audio detection models that were trained on “clean” audio files, as the distorted or transformed audio from the operating system's audio mixer introduces characteristics vastly different from the training data, leading to degraded model performance when deployed on endpoints.

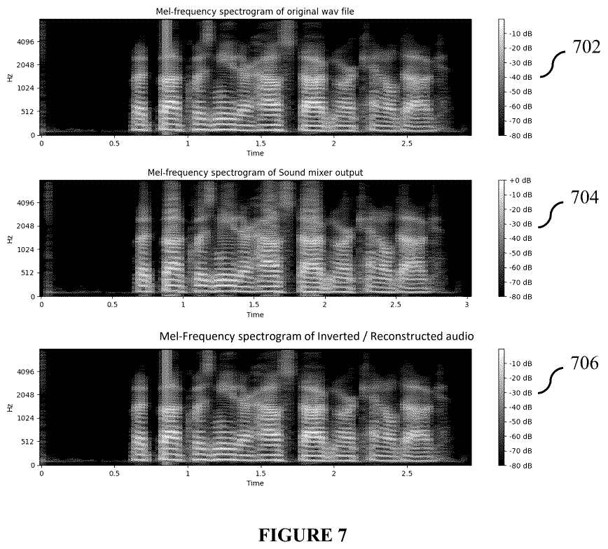

Audio inverter module 112 (as shown in FIG. 1) processes audio passed through the operating system's audio mixer, reconstructing it to approximate the original audio file's characteristics by removing transformations or distortions introduced by the audio mixer. Exemplary reconstructed audio characteristics of an original audio file are illustrated in FIG. 7 where spectrogram 702 illustrates the spectrogram of the original audio file, spectrogram 704 illustrates the spectrogram of the audio file after it has been modified by the OS audio mixer and spectrogram 706 illustrates the spectrogram after spectrogram 704 has been processed by audio inverter module 112. This approach ensures that the reconstructed audio (i.e., spectrogram 706) closely resembles the data used for training deepfake audio detection models, thereby mitigating performance degradation caused by the distortions introduced by the audio mixer.

In embodiments of the disclosure, audio inverter module 112 comprises an audio inverter model that may be implemented as a bi-directional Long Short-Term Memory (LSTM) neural network, although convolutional neural network, or recurrent neural network (e.g., gated recurrent units) based architectures may also be used in other embodiments. The audio inverter model may be trained using a Root Mean Square Error (RMSE) loss function, which minimizes the differences between the reconstructed spectrum and the original audio file's spectrum. To further enhance training efficiency, optimizers with varying learning rates may also be employed, ensuring robust convergence and accurate reconstruction of the original audio characteristics.

The spectrograms in FIG. 7 show that the audio inverter model significantly improves audio reconstruction, as the reconstructed spectrogram, i.e., spectrogram 706, closely match those of the original audio files, i.e., spectrogram 702. This means that through the use of the audio inverter model, the transformations performed by the operating system's audio mixer may be addressed and negated ensuring that the deepfake audio detection model may perform its task reliably, even when computing module 100 is deployed on endpoints where audio is processed through the operating system's mixer.

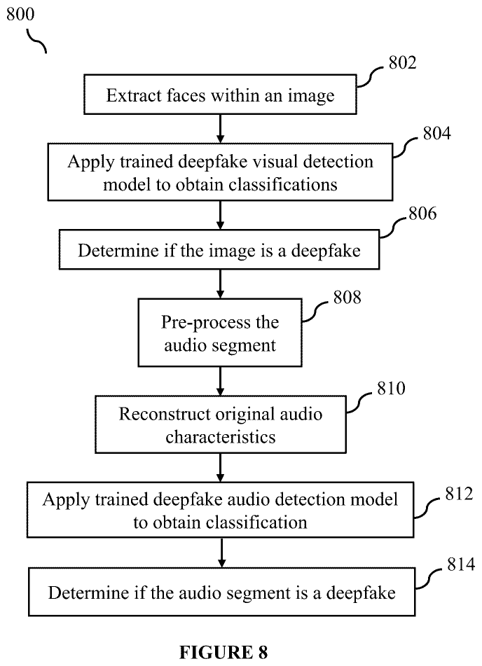

A process for real-time detection of deepfakes is illustrated in FIG. 8 whereby process 800 may be carried out by a computing module that is communicatively coupled to an endpoint such as a desktop, a laptop, etc. in accordance with embodiments of the disclosure.

Process 800 begins at step 802 with process 800 acquiring an image and extracting at least one facial image from the image. At step 804, process 800 then proceeds to apply a trained deepfake visual detection model to the at least one extracted facial image where the visual model performs a binary classification of the at least one facial image to determine if the at least one facial image comprises manipulations and a per-pixel classification of the at least one facial image to generate a mask indicating regions of potential manipulation. Process 800 then determines at step 806 if the acquired image comprises a deepfake image based on the binary and the per-pixel classifications of the at least one facial image.

At step 808, process 800 then acquires an audio segment and pre-processes the audio segment. Process 800 then reconstructs original audio characteristics of the pre-processed audio segment using a trained audio inverter model. This takes place at step 810. At step 812, a trained deepfake audio detection model is then applied by process 800 to the reconstructed original audio characteristics where the audio model performs classification of the reconstructed original audio characteristics. At step 814, process 800 then determines if the acquired audio segment comprises a deepfake audio based on the classification of the reconstructed original audio characteristics.

In other embodiments of the disclosure, process 800 reconstructs the original audio characteristics by causing the trained audio inverter model to reverse transformations introduced by the operating system sound mixer to reconstruct the original audio characteristics approximating an original audio signal of the acquired audio segment.

In other embodiments of the disclosure, the audio inverter model used in process 800 comprises a bi-directional long short-term memory neural network that was trained based on a dataset of audio-transformations representative of distortions introduced by the operating system sound mixer.

In other embodiments of the disclosure, the audio inverter model used in process 800 comprises a convolutional neural network that was trained based on a dataset of audio-transformations representative of distortions introduced by the operating system sound mixer.

In other embodiments of the disclosure, the deepfake visual detection model used in process 800 was trained based on a plurality of deepfake facial images, each deepfake facial image being paired with a difference mask, and a plurality of real facial images that correspond to each deepfake facial image, each real facial image being paired with a corresponding zero-difference mask.

In other embodiments of the disclosure, the deepfake visual detection model used in process 800 comprises a MobileNet image segmentation model configured to segment a received extracted facial image and generate a manipulation mask which comprises the per-pixel classifications of the at least one facial image, a concatenation module configured to concatenate the manipulation mask with the received extracted facial image to produce a multi-channel output, a first convolutional neural network configured to apply same convolution to the multi-channel output to extract spatial features and to preserve input dimensions, a second convolutional neural network configured to apply valid convolution to processed output of the first convolutional neural network to reduce spatial dimensions and increase feature depth of the processed output, a first flattening layer configured to flatten processed output of the second convolutional neural network into a one-dimensional feature vector, and a first multi-layer perceptron neural network configured to process the feature vector to generate the binary classification.

In other embodiments of the disclosure, the deepfake audio detection model used in process 800 was trained based on a plurality of labelled deepfake audio segments and a plurality of labelled real audio segments.

In other embodiments of the disclosure, the deepfake audio detection model used in process 800 comprises a third convolutional neural network configured to apply same convolution to a frequency spectrum derived from received audio characteristics to extract spatial features and to preserve input dimensions, a fourth convolutional neural network configured to apply valid convolution to processed output of the third convolutional neural network to reduce spatial dimensions and increase feature depth of the processed output, and a second multi-layer perceptron neural network configured to generate the classification of the reconstructed original audio characteristics based on processed output of the fourth convolutional neural network.

In other embodiments of the disclosure, the deepfake audio detection model used in process 800 comprises a third convolutional neural network configured to apply same convolution to a frequency spectrum derived from received audio characteristics to extract spatial features and to preserve input dimensions, a fourth convolutional neural network configured to apply valid convolution to processed output of the third convolutional neural network to reduce spatial dimensions and increase feature depth of the processed output, a trained Wav2Vec model configured to process the received audio characteristics to extract temporal features, a concatenation module configured to combine processed output of the fourth convolutional neural network with processed output from the Wav2Vec model, and a second multi-layer perceptron neural network configured to generate the classification of the reconstructed original audio characteristics based on the concatenated output of the concatenation module.

In other embodiments of the disclosure, process 800 generates an alert notification when it is determined that the acquired image comprises a deepfake image or the acquired audio segment comprises a deepfake audio.

Numerous other changes, substitutions, variations, and modifications may be ascertained by the skilled in the art and it is intended that the present application encompass all such changes, substitutions, variations, and modifications as falling within the scope of the appended claims.

1. A computing module for real-time detection of deepfakes comprising:
a processing unit; and
a non-transitory media readable by the processing unit, the media storing instructions that when executed by the processing unit causes the processing unit to:
acquire an image and extract at least one facial image from the image;
apply a trained deepfake visual detection model to the at least one extracted facial image, the visual detection model performing:
a binary classification of the at least one facial image to determine if the at least one facial image comprises manipulations;
a per-pixel classification of the at least one facial image to generate a mask indicating regions of potential manipulation;
determine if the acquired image comprises a deepfake image based on the binary and the per-pixel classifications of the at least one facial image;
acquire an audio segment and pre-process the audio segment;
reconstruct original audio characteristics of the pre-processed audio segment using a trained audio inverter model;
apply a trained deepfake audio detection model to the reconstructed original audio characteristics, the audio detection model performing classification of the reconstructed original audio characteristics;
determine if the acquired audio segment comprises a deepfake audio based on the classification of the reconstructed original audio characteristics.

2. The computing module according to claim 1, whereby the reconstructing of the original audio characteristics comprises instructions for directing the processing unit to:
cause the trained audio inverter model to reverse transformations introduced by the operating system sound mixer to reconstruct the original audio characteristics approximating an original audio signal of the acquired audio segment.

3. The computing module according to claim 1, wherein the audio inverter model comprises a bi-directional long short-term memory neural network that was trained based on a dataset of audio-transformations representative of distortions introduced by the operating system sound mixer.

4. The computing module according to claim 1, wherein the audio inverter model comprises a convolutional neural network that was trained based on a dataset of audio-transformations representative of distortions introduced by the operating system sound mixer.

5. The computing module according to claim 1, wherein the deepfake visual detection model was trained based on:
a plurality of deepfake facial images, each deepfake facial image being paired with a difference mask, and
a plurality of real facial images that correspond to each deepfake facial image, each real facial image being paired with a corresponding zero-difference mask.

6. The computing module according to claim 1, wherein the deepfake visual detection model comprises:
a MobileNet image segmentation model configured to segment a received extracted facial image and generate a manipulation mask which comprises the per-pixel classifications of the at least one facial image;
a concatenation module configured to concatenate the manipulation mask with the received extracted facial image to produce a multi-channel output;
a first convolutional neural network configured to apply same convolution to the multi-channel output to extract spatial features and to preserve input dimensions;
a second convolutional neural network configured to apply valid convolution to processed output of the first convolutional neural network to reduce spatial dimensions and increase feature depth of the processed output;
a first flattening layer configured to flatten processed output of the second convolutional neural network into a one-dimensional feature vector; and
a first multi-layer perceptron neural network configured to process the feature vector to generate the binary classification.

7. The computing module according to claim 1, wherein the deepfake audio detection model was trained based on a plurality of labelled deepfake audio segments and a plurality of labelled real audio segments.

8. The computing module according to claim 1, wherein the deepfake audio detection model comprises:
a third convolutional neural network configured to apply same convolution to a frequency spectrum derived from received audio characteristics to extract spatial features and to preserve input dimensions;
a fourth convolutional neural network configured to apply valid convolution to processed output of the third convolutional neural network to reduce spatial dimensions and increase feature depth of the processed output; and
a second multi-layer perceptron neural network configured to generate the classification of the reconstructed original audio characteristics based on processed output of the fourth convolutional neural network.

9. The computing module according to claim 1, wherein the deepfake audio detection model comprises:
a third convolutional neural network configured to apply same convolution to a frequency spectrum derived from received audio characteristics to extract spatial features and to preserve input dimensions;
a fourth convolutional neural network configured to apply valid convolution to processed output of the third convolutional neural network to reduce spatial dimensions and increase feature depth of the processed output;
a trained Wav2Vec model configured to process the received audio characteristics to extract temporal features;
a concatenation module configured to combine processed output of the fourth convolutional neural network with processed output from the Wav2Vec model; and
a second multi-layer perceptron neural network configured to generate the classification of the reconstructed original audio characteristics based on the concatenated output of the concatenation module.

10. The computing module according to claim 1, further comprising instructions for directing the processing unit to:
generate an alert notification when it is determined that the acquired image comprises a deepfake image or the acquired audio segment comprises a deepfake audio.

11. A method for real-time detection of deepfakes using a computing module, the method comprising the steps of:
acquiring an image and extracting at least one facial image from the image;
applying a trained deepfake visual detection model to the at least one extracted facial image, the visual detection model performing:
a binary classification of the at least one facial image to determine if the at least one facial image comprises manipulations;
a per-pixel classification of the at least one facial image to generate a mask indicating regions of potential manipulation;
determining if the acquired image comprises a deepfake image based on the binary and the per-pixel classifications of the at least one facial image;
acquiring an audio segment and pre-process the audio segment;
reconstructing original audio characteristics of the pre-processed audio segment using a trained audio inverter model;
applying a trained deepfake audio detection model to the reconstructed original audio characteristics, the audio detection model performing classification of the reconstructed original audio characteristics;
determining if the acquired audio segment comprises a deepfake audio based on the classification of the reconstructed original audio characteristics.

12. The method according to claim 11, whereby the step of reconstructing the original audio characteristics comprises the steps of:
causing the trained audio inverter model to reverse transformations introduced by the operating system sound mixer to reconstruct the original audio characteristics approximating an original audio signal of the acquired audio segment.

13. The method according to claim 11, wherein the audio inverter model comprises a bi-directional long short-term memory neural network that was trained based on a dataset of audio-transformations representative of distortions introduced by the operating system sound mixer.

14. The method according to claim 11, wherein the audio inverter model comprises a convolutional neural network that was trained based on a dataset of audio-transformations representative of distortions introduced by the operating system sound mixer.

15. The method according to any one of claim 11, wherein the deepfake visual detection model was trained based on:
a plurality of deepfake facial images, each deepfake facial image being paired with a difference mask, and
a plurality of real facial images that correspond to each deepfake facial image, each real facial image being paired with a corresponding zero-difference mask.

16. The method according to claim 11, wherein the deepfake visual detection model comprises:
a MobileNet image segmentation model configured to segment a received extracted facial image and generate a manipulation mask which comprises the per-pixel classifications of the at least one facial image;
a concatenation module configured to concatenate the manipulation mask with the received extracted facial image to produce a multi-channel output;
a first convolutional neural network configured to apply same convolution to the multi-channel output to extract spatial features and to preserve input dimensions;
a second convolutional neural network configured to apply valid convolution to processed output of the first convolutional neural network to reduce spatial dimensions and increase feature depth of the processed output;
a first flattening layer configured to flatten processed output of the second convolutional neural network into a one-dimensional feature vector; and
a first multi-layer perceptron neural network configured to process the feature vector to generate the binary classification.

17. The method according to claim 11, wherein the deepfake audio detection model was trained based on a plurality of labelled deepfake audio segments and a plurality of labelled real audio segments.

18. The method according to claim 11, wherein the deepfake audio detection model comprises:
a third convolutional neural network configured to apply same convolution to a frequency spectrum derived from received audio characteristics to extract spatial features and to preserve input dimensions;
a fourth convolutional neural network configured to apply valid convolution to processed output of the third convolutional neural network to reduce spatial dimensions and increase feature depth of the processed output; and
a second multi-layer perceptron neural network configured to generate the classification of the reconstructed original audio characteristics based on processed output of the fourth convolutional neural network.

19. The method according to claim 11, wherein the deepfake audio detection model comprises:
a third convolutional neural network configured to apply same convolution to a frequency spectrum derived from received audio characteristics to extract spatial features and to preserve input dimensions;
a fourth convolutional neural network configured to apply valid convolution to processed output of the third convolutional neural network to reduce spatial dimensions and increase feature depth of the processed output;
a trained Wav2Vec model configured to process the received audio characteristics to extract temporal features;
a concatenation module configured to combine processed output of the fourth convolutional neural network with processed output from the Wav2Vec model; and
a second multi-layer perceptron neural network configured to generate the classification of the reconstructed original audio characteristics based on the concatenated output of the concatenation module.

20. The method according to claim 11, further comprising the steps of:
generating an alert notification when it is determined that the acquired image comprises a deepfake image or the acquired audio segment comprises a deepfake audio.
